(19) United States
(12) Patent Application Publication
(10) Pub. No.: US 2011/0038697 A1
(43) Pub. Date: Feb. 17, 2011

(54) SIDE LOADING REFUSE COLLECTION SYSTEM

(76) Inventors: Carlos Arrez, Berwyn, IL (US); Ramiro Arrez, Orland Park, IL (US)

Correspondence Address: COOK ALEX LTD, SUITE 2850, 200 WEST ADAMS STREET, CHICAGO, IL, 60606, US

(21) Appl. No.: 12/855,047

(22) Filed: Aug. 12, 2010

Related U.S. Application Data
(60) Provisional application No. 61/234,387, filed on Aug. 17, 2009.

(51) Int. Cl. B65F 3/04; B65F 3/06; B25J 15/02; B66C 1/44; B65F 1/10

(52) U.S. Cl. 414/408; 414/404; 294/88

(57) ABSTRACT

A cart lifter is provided that is adapted to be mounted to a refuse container or directly to a refuse collection vehicle. A support is provided that is adapted to be pivotally mounted adjacent to the loading area of either the refuse container or the vehicle. First and second support arms are provided that are carried by the pivoting support. The support arms are movable relative to a support frame between a first position in which the support arms are adjacent the refuse container or vehicle and a second position in which the support arms are relatively angularly disposed with their free ends being spaced outwardly away from the support frame. A container capturer is provided for engaging and releasing a smaller refuse collection cart, and the free ends of each of the support arms are adapted to carry the container capturer. Actuators are provided for dumping or inverting the refuse collection cart, to move the support arms between the first position for storage and/or dumping and the second position for capturing or releasing a cart, and for actuating the container capturer so that it can engage and release the refuse collection cart.

### CROSS REFERENCE TO RELATED APPLICATION

This application claims the benefit of the filing date of U.S. Provisional Patent Application Ser. No. 61/234,387, filed Aug. 17, 2009, the entire contents of which are incorporated by reference herein.

### FIELD OF DISCLOSURE

The present disclosure relates to a refuse container or cart lifter. The lifter may be mounted to a stationary or mobile container, compacting container, side loading refuse collection vehicle or other type of receptacle. The lifter is particularly adapted to be mounted to a side face of a larger front-load refuse receptacle that is removably mounted to, e.g., a pair of forks that carry the larger refuse receptacle in front of a refuse collection vehicle, and invert to the larger refuse receptacle to dump its contents into a body or chamber located rearward of the cab of the vehicle. The lifter is also particularly adapted to be mounted to the side of a refuse collecting vehicle rearwardly of the cab so that the lifter can dump refuse collection carts directly into the body or chamber located behind the cab.

### BACKGROUND OF THE INVENTION

Front load refuse collection vehicles are in wide use in large-scale residential refuse collection. A front load refuse collection vehicle typically has a front cab, a large refuse compartment behind the cab, and a pair of hydraulic-powered lift forks extending in front of the vehicle that are adapted to be inserted into corresponding slots or sleeves associated with an intermediate size portable refuse collection container. The forks are able to lift the refuse container over the front of the vehicle and invert the container to dump its contents into the refuse compartment or body located behind the cab.

For residential and small-scale refuse collection, the collection container often is carried in front of the collection vehicle as it moves along the street. The contents of smaller residential collection carts are first dumped into the intermediate collection container to fill the intermediate container, and the intermediate container is then inverted to dump its contents into a larger collection bin behind the vehicle cab.

Typically a hydraulic cart lifter is mounted to the intermediate collection container to invert the residential collection cart to dump its contents into the intermediate container. Hydraulic lifters also have been mounted to the intermediate collection container in a manner so that the lifter can be moved laterally relative to the intermediate container into engagement with the residential refuse cart for curb-side collection, rather than requiring the operator to move the refuse receptacle to the lifter. U.S. Pat. Nos. 5,484,245; 5,607,277; 5,639,201; 5,797,715; 5,938,394; and 6,139,244, all of which are hereby incorporated by reference, illustrate such arrangements. An improved side loading system is shown in the co-pending application U.S. Ser. No. 11/736,167, filed Apr. 17, 2007 (U.S. Pub. No. 2007/0243050), herein incorporated by reference. The present application discloses further improvements to such a system.

### SUMMARY

In accordance with the present disclosure, a side-loading refuse collection system is provided. The system includes a cart lifter that is adapted to be mounted to either an intermediate refuse container, generally adapted to be carried in front of a refuse collection vehicle, or mounted directly to the side of the refuse compartment of a refuse collection vehicle. A mounting base is provided that is adapted to be secured adjacent to the loading area of either the intermediate refuse container or the vehicle. First, second, third and fourth generally elongated support arms are provided, each having first and second ends. Both of the first and second support arms have their first end pivotally associated with the mounting base and their second end pivotally connected to the first end of the third and fourth support arms, respectively. The first and second support arms are pivotally connected to one another at a position intermediate the ends of the first and second support arms, and the four support arms are movable with respect to the mounting base between a first position in which the support arms lie generally flat against the mounting base and a second position in which the support arms are angularly disposed relative to the mounting base. A base for mounting a cart lifter or, alternatively, a cart capturer, is carried at the second ends of the third and fourth support arms. The second ends of the third and fourth support arms are pivotally secured to the lifter base such that the orientation of the lifter base to the mounting base is maintained throughout the movement of the support arms between the first and second position, the orientation being such that the lifter base remains generally parallel to the mounting base.

In another aspect of the disclosure, a container lifter is provided that comprises a drive base with a rotary actuator including a rotary drive shaft carried by the drive base. A drive arm is provided having first and second ends, with the first end being attached to the rotary drive shaft and the second end having a lifter base carried thereby. First and second gripper arms are provided, each having one end pivotally carried by the lifter base. The gripper arms are movable between a first position in which the arms extend in substantially opposed directions, and a second position in which they extend in substantially the same direction. The drive arm is movable by the actuator between a raised position that elevates the lifter base for dumping a receptacle and a lowered position for engaging or releasing a receptacle. The drive arm includes an offset portion that defines a nesting region for receiving one of the support arms when in the first position, thus permitting the lifter to achieve a low profile when in the retracted position.

In another aspect of the disclosure, a container lifter is provided that comprises a mounting base with first and second gripper arms each having one end pivotally carried by the mounting base. The gripper arms are movable between a first position in which the arms extend in substantially opposed directions and a second position in which they extend in substantially the same direction. A hydraulic actuator carried by the base is movable substantially linearly in the same direction, and a link pivotally connecting each gripper arm to the actuator is provided such that linear movement of the actuator causes movement of the gripper arms between the first and second positions.

In another aspect of the disclosure, a gripper arm for a container lifter is provided in which the gripper arm comprises an elongated first portion that is adapted to be pivotally secured to the container lifter at its first end and a second, tip portion secured to the first portion generally adjacent the other end thereof, the second tip portion extending beyond the distal end of the first portion and being axially displaced therefrom.

Other features and aspects will become apparent upon reference to the accompanying drawings and detailed description.

### BRIEF DESCRIPTION OF THE FIGURES OF THE DRAWINGS

FIGS. 1A-F are perspective views of a side loading refuse collection system according to the present disclosure showing the system secured to a larger front-load refuse receptacle adapted to be carried by a refuse collection vehicle and showing the sequence of operation.

FIG. 2 is a perspective view of an example of a side loading refuse collection system similar to that shown in FIGS. 1A-F, showing the system mounted to the side of a collection vehicle.

FIGS. 3-6 are perspective views of the refuse collection system of FIG. 2.

FIG. 7 is a fragmentary perspective view of the refuse collection system of FIGS. 1A-F showing the cart lifter and grabber mechanism being separated therefrom.

FIG. 8 is a top view of the sub-assembly of the cart grabber mechanism of FIG. 7 for the side loading refuse collection system.

FIG. 9 is an exploded perspective view of the linkage and actuation system for the grabber arm mechanism of FIG. 7.

### DETAILED DESCRIPTION

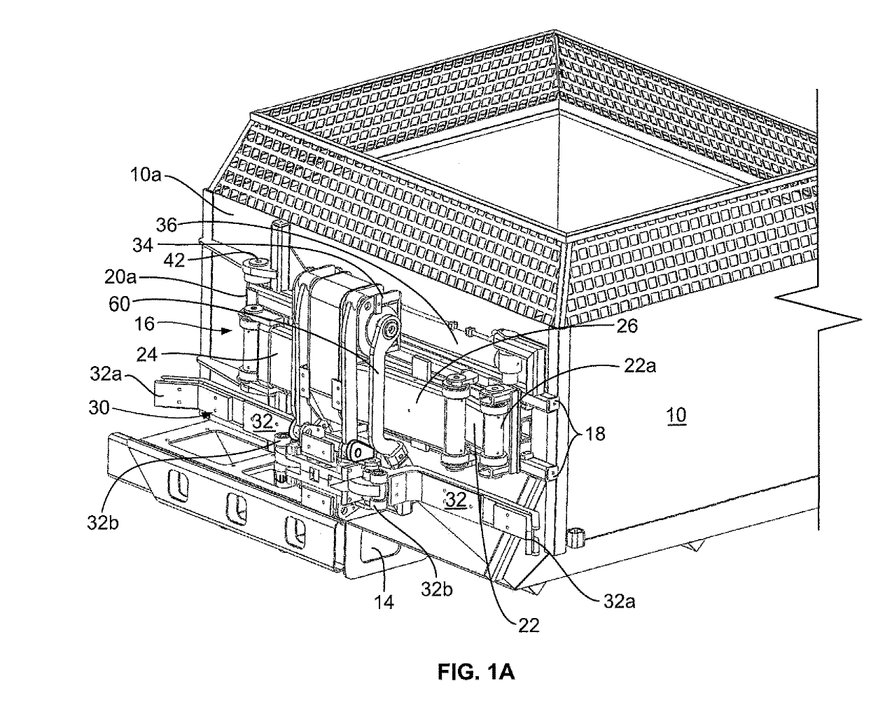

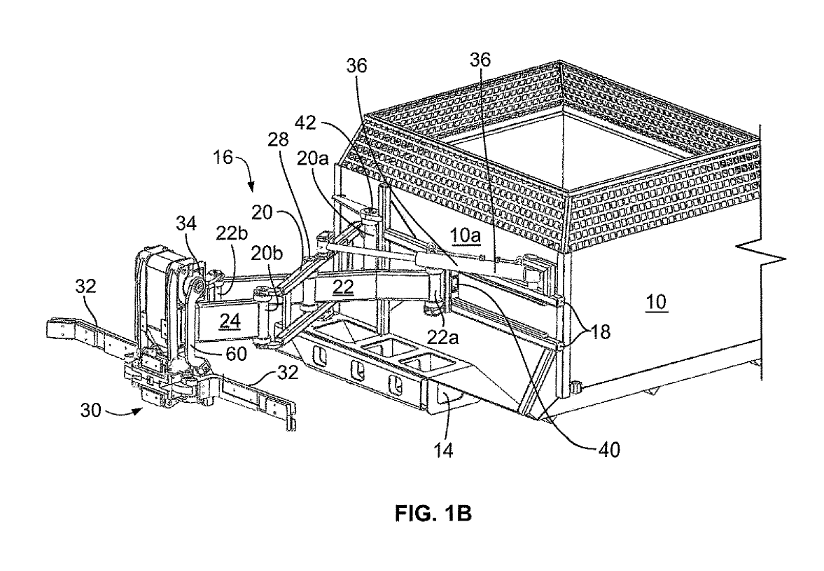

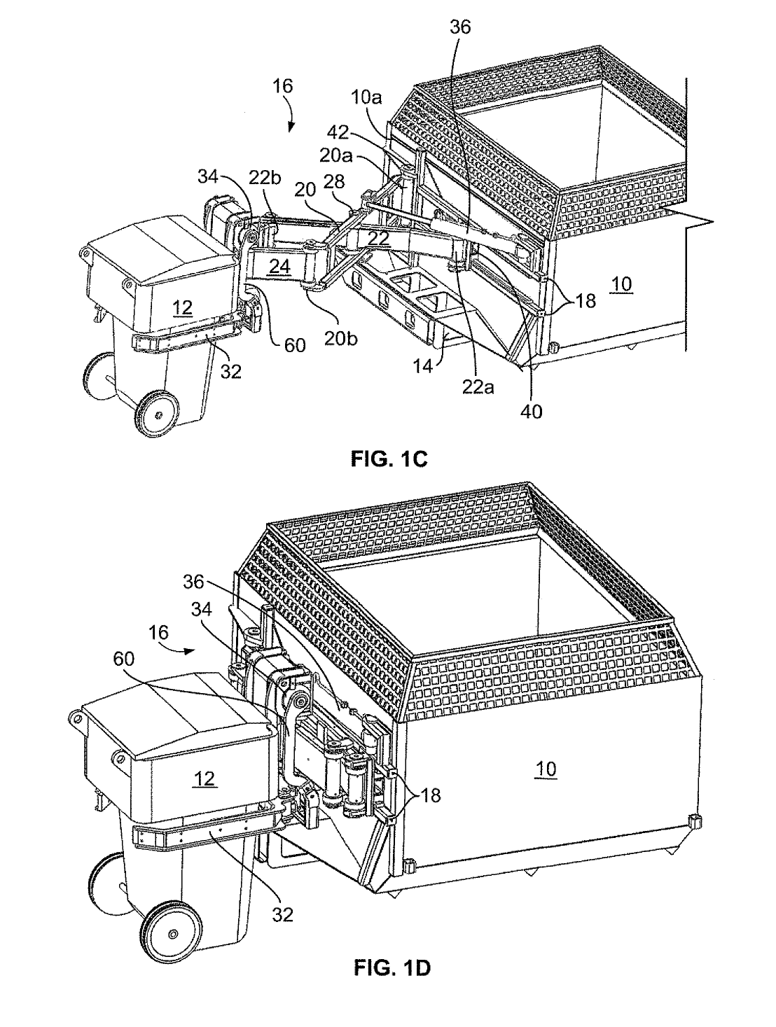

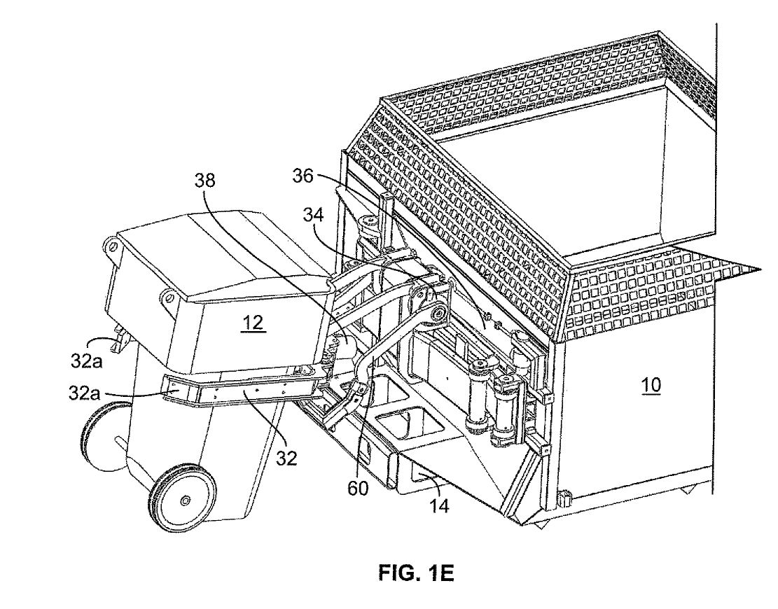

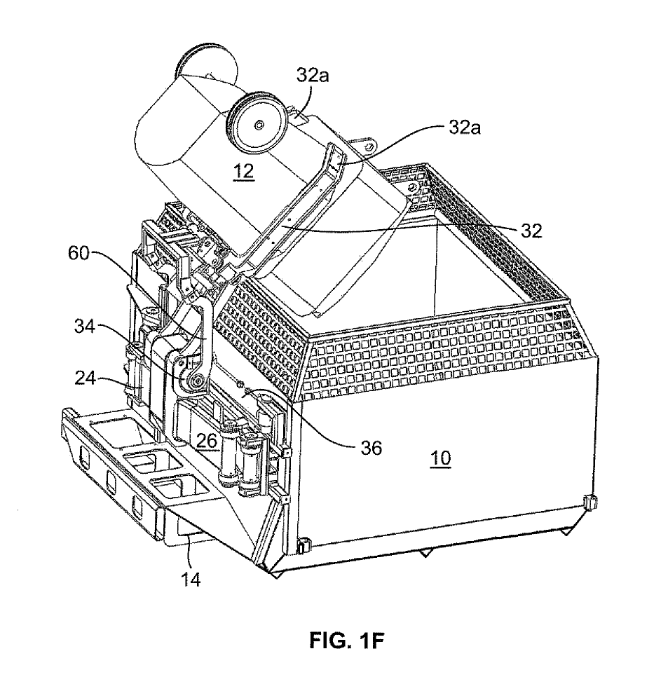

Front load refuse collection vehicles are in wide-spread use in large-scale residential refuse collection. A front load refuse collection vehicle typically has a front cab with a large refuse compartment behind the cab. A pair of hydraulic-powered lift forks extend in front of the truck that are adapted to be inserted into corresponding slots or sleeves associated with an intermediate-size portable refuse collection container, such as the intermediate collection container 10 in FIGS. 1A-F. The forks are able to lift the refuse container 10 over the cab of the truck, and invert the container to dump its contents into the refuse compartment or body located behind the cab.

For residential and small-scale refuse collection, the collection container is often carried in front of the collection vehicle as it moves along the street. The smaller residential collection carts (such as cart 12 in FIGS. 1C-F) are first dumped by cart lifters mounted to the intermediate collection container into the intermediate collection container. Then, the intermediate collection container is inverted to dump its contents into the larger collection bin of the vehicle. The intermediate refuse collection container 10 typically includes sleeves or channels 14 for receiving the lift forks associated with the refuse collection vehicle. The container 10 may also include a modular housing for containing the hydraulic and electronic systems associated with the cart lifter to provide easy access for repair and replacement of the same.

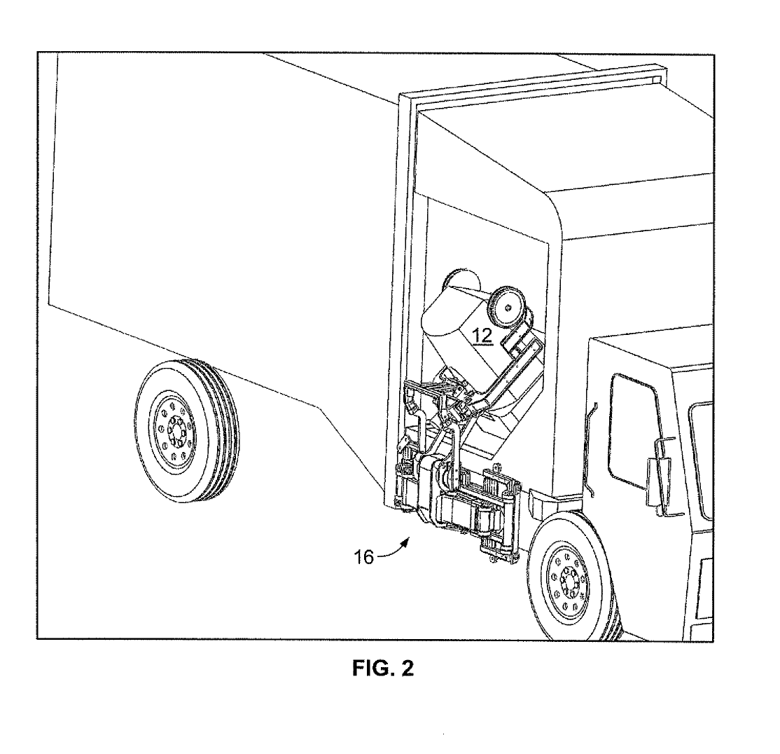

By way of the present disclosure, a container lifter, generally designated 16, is adapted to be mounted to the side wall of the intermediate refuse collection container 10. The lifter 16 comprises a mounting base 18 that is secured or mounted to the intermediate refuse container 10 adjacent to the loading area of the intermediate refuse container. The lifter 16 may, alternatively, be mounted to the front wall of the intermediate refuse collection container 16 without departing from the present invention, although mounting to the side wall is preferred for curb-side residential pickup. Similarly, the container lifter 16 of the present invention also may be mounted to a stationary container or compactor, or to the side of the collection vehicle, as shown in FIG. 2.

The container lifter 16 is adapted to move a container capturer between a first position adjacent the intermediate container 10 and a second position spaced away from the intermediate container to retrieve a residential collection cart. To this end, first, second, third and fourth support arms, designated 20, 22, 24 and 26, respectively, are provided that are carried by the mounting base 18. Each of the first and second support arms 20, 22 has a first end 20a, 22a that is pivotally associated with the mounting base 18 and a second, free end 20b, 22b. The first and second support arms 20, 22 are pivotally connected to each other at a position 28 intermediate their first and second ends, and the first ends 24a, 26a of the third and fourth support arms 24, 26 are pivotally secured to the second or free ends 20b, 22b of the first and second support arms 20, 22, respectively. The four support arms 20, 22, 24 and 26 are movable relative to the mounting base 18 between a first, retracted position (as seen in FIG. 1A), in which the support arms are adjacent the sidewall of the refuse container and are preferably substantially coplanar so as to provide a low profile, and a second, extended position (as seen in FIG. 1B) in which the support arms 20, 22, 24, 26 have their free ends spaced outwardly away from the mounting base 18. The free ends 24b, 26b of the third and fourth support arms 24, 26 support a container capturer 30 having grabber arms 32 for engaging and releasing the residential refuse collection cart 12. Actuators are provided for pivoting the container lifter and/or support frame relative to the container vehicle to dump or invert the refuse collection cart (rotary actuator 34), to move the support arms between the first and second extended positions (piston actuator 36), and to actuate the container capturer grabber arms 32 for engaging and releasing the refuse collection cart (piston actuator 38).

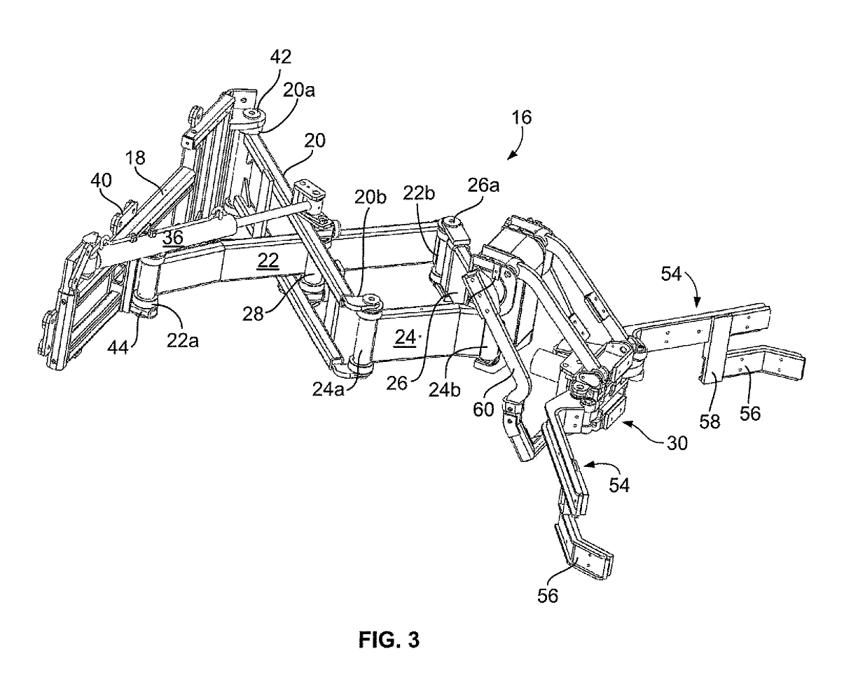

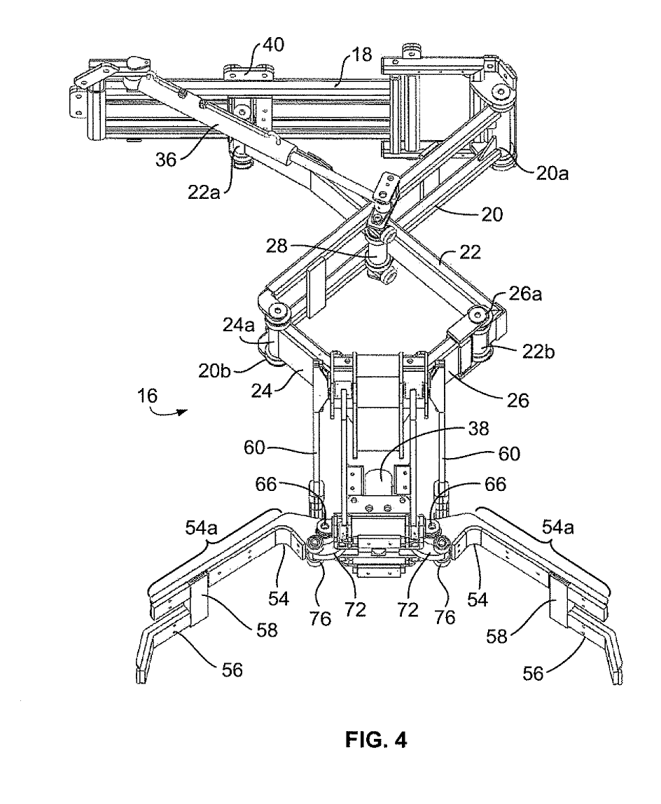

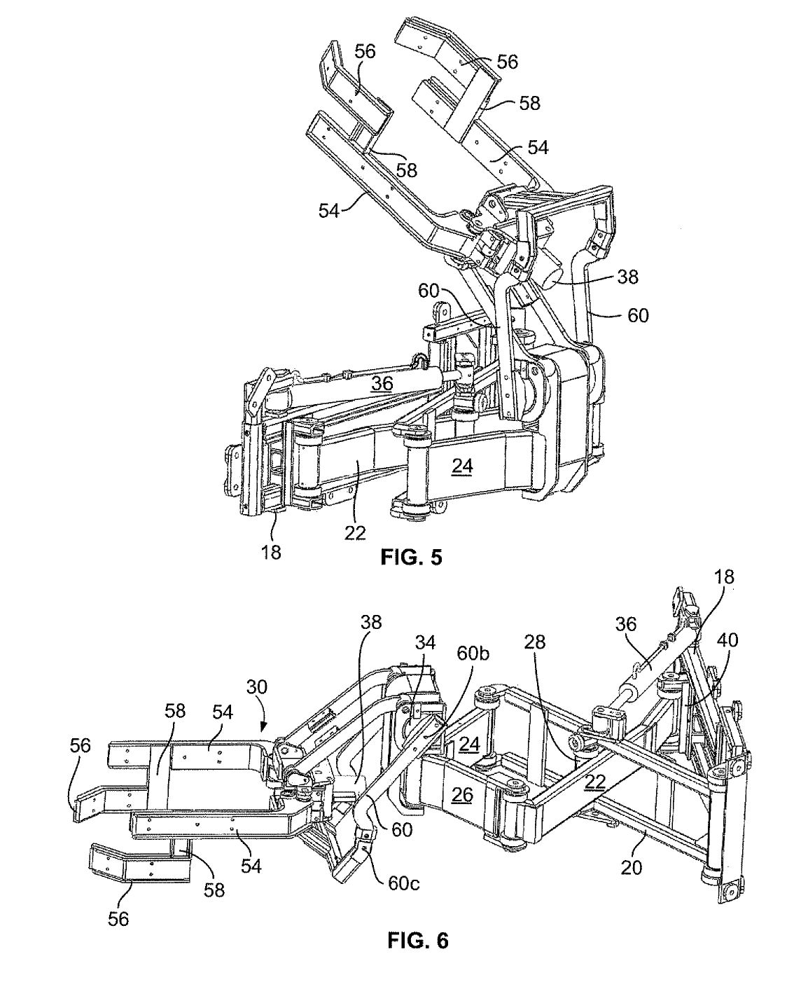

In the illustrated embodiment, mounting base 18 is in the form of generally rectangular open frame that is mounted to a lateral sidewall 10a of the intermediate refuse collection container 10. As best seen in FIGS. 3-6, support arm 20 is pivotally mounted or attached to the one end of the mounting base 18. Support arm 22 is pivotally mounted to a vertical support 40 that is slidably carried by the mounting base 18. Thus, mounting base 18 forms a track on which the vertical support 40 is slidably mounted. As noted above, the first and second support arms 20, 22 also are attached to each other by a pivot pin 28 located intermediate the ends of the support arms 20, 22. Although illustrated with end 20a of arm 20 attached at fixed pivot 42 and the end 22a of arm 22 attached by pivot 44 to the sliding support 40, other variations would be apparent to one skilled in the art. For example, the ends of both pairs of arms could be at fixed pivot points or both could be at slidable pivot points, as more generally described in the copending application U.S. Ser. No. 11/736,167, referenced above.

In keeping with one aspect of the disclosure, the container capturer/tipper assembly is preferably secured to the free ends 24b, 26b of the third and fourth support arms 24, 26 in such a manner that the orientation of the container capturer/tipper assembly is maintained throughout the movement of the lifter 16 between the retracted and extended positions. This ensures that the face plate of the container capturer/tipper, against which the residential cart 12 is held by the gripper arms, maintains its orientation of being generally parallel to the mounting base 18. Otherwise, the container capturer/tipper assembly could swivel freely, and uncontrollably, with respect to the free ends 24b, 26b of the support arms 24, 26 as the lifter 16 moves between the retracted and extended positions.

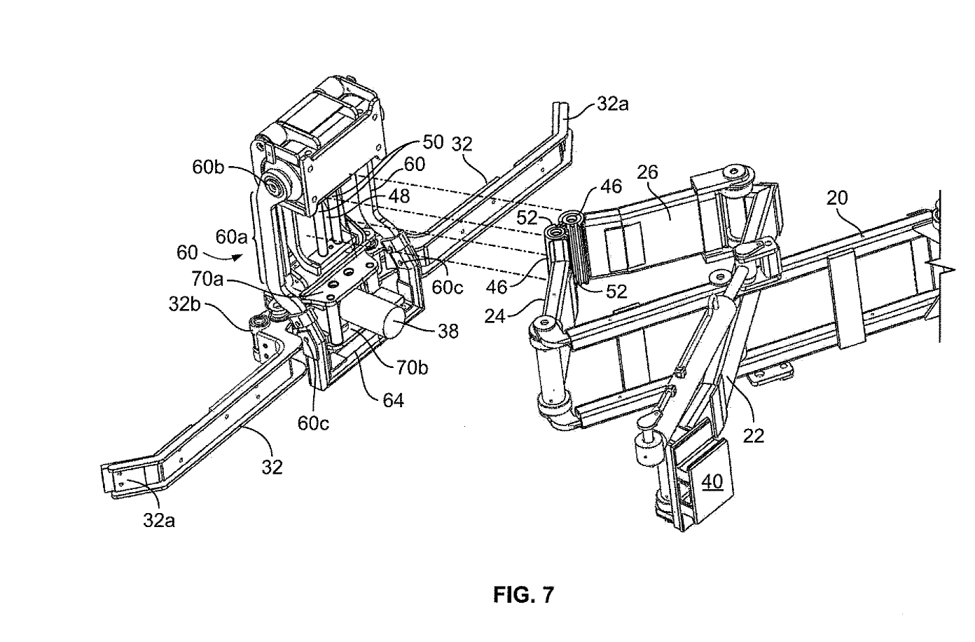

With reference to the drawings, the ends 24b, 26b of the support arms 24, 26 are each provided with a vertically-oriented sleeve 46 (best seen in FIG. 7), with free ends 24b, 26b being secured to a mounting plate 48 for the container capturer/tipper by means of pivot bolts 50 that provide parallel axes about which the support arms 24, 26 pivot relative to the container capturer/tipper assembly. The pivot sleeves 46 are provided with outer surfaces 52 that engage each other that ensure that, as the lifter assembly 16 moves between the retracted and extended positions, the support arms 24, 26 move in a predictable and symmetric manner. As shown in the illustrated embodiment, at least a portion of the outer surfaces 52 of the pivot sleeves 46 of the support arms 24, 26 are provided with teeth or splines that intermesh to maintain the free ends 24b, 26b in registration with each other, thus controlling the degree to which the sleeves 46 pivot relative to each other as the support arms move between the retracted and extended positions. Specifically, the outer meshing teeth insure that both sleeves 46 pivot an equal amount relative to the mounting plate 48. Other structures for controlling the relative pivoting of the sleeves 46 may be provided as would occur to a person of ordinary skill.

As shown in FIGS. 1A-F, the grabber arms 32 have a generally linear configuration with an angled end or tip 32A. This works well for applications in which the lifter 16 is mounted relatively close to the ground, such as on an intermediate collection container 10 of the type shown in FIGS. 1A-F, to ensure ground clearance. In keeping with another aspect of the disclosure, the grabber arm may be configured to allow the arm to firmly engage a residential collection cart if the lifter system is mounted relatively higher relative to the ground, as may be desired to provide clearance. As best seen in FIGS. 3-6, the example grabber arm 54 includes a second, separate tip portion 56 that is secured to the first, main portion 54a adjacent its distal or termination end 54b, and extends axially beyond the distal/termination end of the first portion and is secured to the main portion 54a by a bracket 58 so that it is displaced or spaced axially therefrom. The tip portion 56 is preferably provided with an end that is angularly disposed with respect to the remainder of the gripper arm to facilitate engagement with the outer surface of the collection cart 12.

Because the lifter system 16 of the present disclosure is adapted to be mounted to the side of a collection container or truck, it is desirable for the system 16 to present a low profile when in the retracted position so as to permit the collection container and/or truck to which the lifting system is mounted to travel on narrow roadways or alleys. This reduces the likelihood of the lifter 16 colliding with an object adjacent to the path of travel. Thus, it is desirable that the container capturer 30 be configured so that it presents a low profile when the lifter system 16 is in the retracted position. To this end, the tipper mechanism for the container capturer includes a pair of driver arms 60 that connect the container capturer 30 to the rotary actuator 34. The driver arms 60 are configured so as to generally overlie one or more of the support arms 20, 22, 24, 26 (when the lifter system 16 is in the retracted position as shown in FIG. 1A), with a significant portion of the container capturer 30 being disposed underneath the folded support arms. As shown in FIGS. 1A-F, and 7, this may be accomplished by having a driver arm 60 configured to have an intermediate portion 60a that is displaced from alignment with the ends 60b, 60c of the driver arm 60 that are attached to the rotary actuator (end 60b) and to the container capturer (end 60c). In the embodiment of FIGS. 2-6, the intermediate section 60a is displaced only with respect to the end of the driver arm 60c that is pivotally connected to the container capturer. In both instances, the intermediate section 60a is offset with respect to the pivot connection 62 to the container capturer 30 so as to define a nesting region for one or more of the support arms 20, 22, 24, 26 when the lifter 16 is in the retracted position.

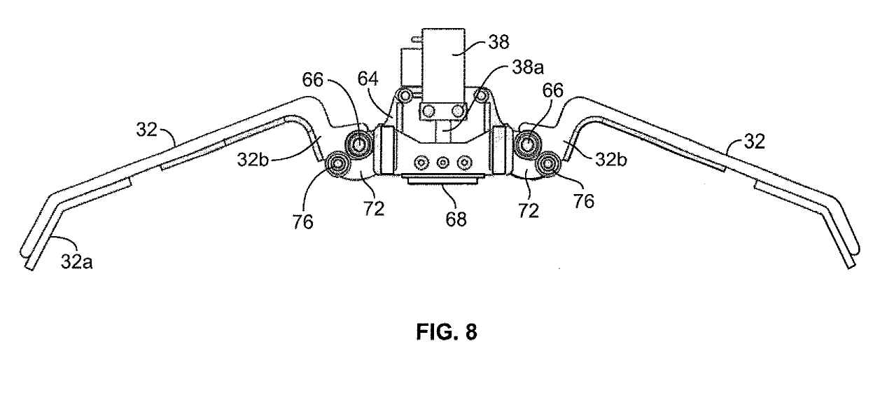

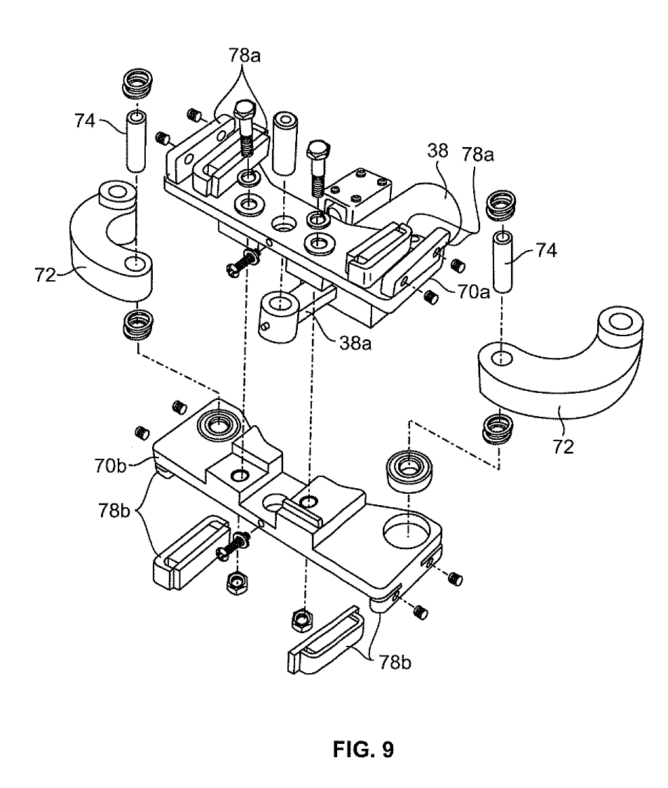

In keeping with another aspect of the disclosure, a novel mechanism is provided for moving the grabber arms 32 between a first position for storage of the lifter or release of the collection cart, in which the grabber arms 32 extend in generally opposite directions (e.g. FIGS. 1A-B), and a second position for engaging and holding the collection cart, in which the grabber arms 32 extend in generally the same direction (e.g., FIGS. 1C-F). To this end, the container capturer 30 comprises a mount 64 to which one end 32b of each grabber arm 32 is mounted by a pivot 66. As best seen in FIGS. 8 and 9, the actuator 38 is secured to the mount 64 such that its piston rod 38a moves in a direction generally perpendicular to the face plate 68 on the mount 64, or generally in the same direction as that of the grabber arms 32 when in the second position for engaging a collection cart.

The free end of the piston rod 38a is secured to a mounting bracket preferably having a top plate 70a and a bottom plate 70b. A link 72 for each grabber arm 32 is secured between the top plate and bottom plate, with each link having one end pivotally secured to the top and bottom plates 70a, 70b by a pivot pin 74 and having the other end pivotally secured to the grabber arm 32 at a pivot connection 76. Thus, linear movement of the piston rod 38a moves the grabber arms 32 between the first and second positions. The mounting member 64 also is preferably configured so as to have a pair of guide tracks 78a, 78b associated with each of the top plate 70a and bottom plate 70b, respectively. The guide tracks 78a, 78b mate or nest with complementarily-shaped slide surfaces on the container capturer mount. The guide tracks 78a, 78b may be made of a resilient material, such as a UHMW plastic with a rubber or rubber-like surface that accommodates relative misalignment of the grabber arms 32 during the actuation thereof.

Other mechanisms for moving the grabber arms 46 may be used. See, e.g., Published U.S. Pat. Appln. 2005/0095097, (U.S. Ser. No. 10/691,989), incorporated herein by reference. In addition, other lifter mechanisms well known in the art for selectively engaging and releasing residential-size refuse collection carts also may be used, such as lifter mechanisms employing upper and lower hooks for engaging the bars on the collection cart. See. e.g., U.S. Pat. Nos. 6,929,441 and 4,773,812 which also are incorporated herein by reference.

A description of a typical sequence of operation of the container lifter 20 follows. In use, in the normal pick-up mode, the intermediate refuse collection container 10 is carried on lifter forks in front of the collection vehicle cab. With the lifter 16 in the retracted position (FIG. 1A), the vehicle stops so that the intermediate refuse receptacle 10 is spaced laterally from a residential refuse collection cart. The actuator 36 is activated, moving the first ends 20a, 22a of the first and second support arms 20, 22 toward each other so that the second or free ends 20b, 22b move away from the first position adjacent to the lateral side wall 10a of the front-load refuse receptacle 10 to the second position extending toward a residential refuse collection cart (FIG. 1B). Actuator 38 is then activated so that the grabber arms 32 capture the residential refuse collection cart 12 (FIG. 1C). Then, after a slight lifting of the cart 12 off the ground by pivoting the container capturer 30 with the rotary actuator 34, the actuator 36 is activated again to draw the support arms 20, 22, 24, 26 and the associated container capturer 30, along with the residential refuse collection cart 12, back toward the intermediate, front-load refuse receptacle 10 (FIG. 1D).

The rotary actuator 34 is then activated to fully tip the container capturer 30 with respect to the side wall of the collection container 20, thus moving the residential collection cart 12 to an inverted dumping position to empty the contents of the cart 12 into the intermediate collection container 10 (FIGS. 1E and 1F). The steps are then performed in reverse order to return the residential collection cart 12 to its original position. After the cart 12 is released, the lifter 16 is retracted to its first position adjacent the side wall 10a of the collection container 10 (FIG. 1A).

While the lifter according to the present invention may be advantageously mounted to the side wall of a fork-mounted intermediate collection container, as shown in FIG. 1, the lifter also may be mounted directly to the side of the collection vehicle to dump the contents of a collection cart directly into the collection container mounted to the collection vehicle rearward of the vehicle cab, as shown in FIG. 2.

Further, while the container lifter has been described as having an actuator for tipping the container capturer, tipping could also be accomplished by having the mounting base pivotally secured to the sidewall of the intermediate container or side wall of the collection vehicle, as shown and described in the above-referenced copending application U.S. Ser. No. 11/736,167.

Thus, a cart lifter has been disclosed having various advantages and features. While the cart lifter has been disclosed in terms of certain preferred embodiments, there is no intent to limit the invention to the same. Instead, the invention is defined by the following claims.

1. A cart lifter adapted to be mounted to a refuse container or vehicle, the lifter comprising:
a mounting base adapted to be mounted adjacent to a loading area of a refuse container or vehicle;
first, second, third and fourth generally elongated support arms, each having first and second ends and being carried by the base, each of the first and second support arms having its first end pivotally associated with the mounting base and its second end pivotally connected to the first end of the third and fourth support arms, respectively, the first and second support arms being pivotally connected with one another at a position intermediate the ends of the first and second support arms; the support arms being movable with respect to the mounting base between a first position in which the support arms lie generally flat against the mounting base and a second position in which the support arms are angularly disposed relative to the mounting base; and
a lifter base carried at the second ends of the third and fourth support arms adapted for securing a refuse container capturer thereto, wherein the second ends of the third and fourth support arms are pivotally secured to the lifter base such that the lifter base is maintained in a position generally parallel to the mounting base throughout the movement of the support arms between the first and second positions.

2. The cart lifter of claim 1 wherein the second ends of the third and fourth support arms are pivotally secured to the lifter base about parallel axes, the second ends of the third and fourth support arms being in registration with one another.

3. The cart lifter of claim 2 wherein the second ends of the third and fourth support arms are provided with intermeshing teeth to maintain the support arms in registration.

4. The cart lifter of claim 1 further comprising a container lifter secured to the lifter base, the container lifter comprising a rotary actuator having an output shaft, at least one driver arm having first and second ends, the first end being secured to the output shaft of the actuator and a second end being pivotally connected to a container capturer, the driver arm having an intermediate segment displaced outwardly from direct alignment with the second end of the driver arm so that when the support arms are in the first position, the cart lifter maintains a generally low profile relative to the refuse container or vehicle to which it is mounted.

5. A container lifter comprising:
a drive base;
a rotary actuator including a rotary drive shaft carried by the base;
a drive arm having first and second ends, the first end being attached to the drive shaft;
a lifter base carried at the second end of the drive arm;
first and second gripper arms having first and second ends, the first end of each gripper arm being pivotally carried by the lifter base and movable between a first position in which the gripper arms extend in substantially opposed directions and a second position in which the gripper arms extend in substantially the same direction;
the drive arm being movable by the actuator between a raised position elevating the lifter base for dumping a receptacle and a lowered position for engaging or releasing a receptacle;
the drive arm including an offset portion defining a nesting region for receiving at least one support arm to which the drive base is connected.

6. A gripper arm for a refuse container capturer having a pair of gripper arms, the gripper arm comprising an axially elongated first portion having proximal and distal ends, the first portion being adapted to be pivotally secured to a container lifter at its proximal end; and a second tip portion secured to the first portion generally adjacent to the distal end thereof, the second tip portion extending beyond the distal end of the first portion and being axially displaced therefrom.

7. The gripper arm of claim 6 wherein the second tip portion has a proximal portion and a distal portion, the proximal portion being secured to the first portion of the gripper arm and the distal portion of the second tip portion being angularly displaced from the proximal portion.

8. The gripper arm of claim 6 wherein the second portion of the gripper arm is secured so as to be in generally parallel relationship to the first portion.

9. A container lifter comprising:
a lifter base;
first and second gripper arms having first and second end portions, the first end portion of each gripper arm being pivotally carried by the lifter base and movable between a first position in which the arms extend in substantially opposed directions and a second position in which the arms extend in substantially the same direction;
the second end portion of each gripper arm including a first main arm portion having a first termination end and a second arm portion carried by the main arm portion and spaced therefrom and extending in substantially the same direction as the main arm portion to a second termination end beyond the first termination end.

10. A container capturer comprising:
a mount;
first and second gripper arms having first and second ends, the first end of each gripper arm being pivotally secured to the mount;
a face plate secured to the mount for abutting a refuse collection cart;
a hydraulic actuator comprising a cylinder and a piston secured to the mount such that the piston moves generally perpendicularly to the face plate;
a bracket mounted to the free end of the piston; and
a link pivotally connecting each gripper arm to the bracket.

11. The assembly of claim 10 wherein the mount comprises a guide track for the bracket.

12. The assembly of claim 11 wherein the guide track comprises a resilient material.

13. A container lifter comprising:
a mounting base;
first and second gripper arms having first and second ends, the first end of each gripper arm being pivotally carried by the mounting base and movable between a first position in which the arms extend in substantially opposed directions and a second position in which the arms extend in substantially the same direction;
a hydraulic actuator carried by the base movable substantially linearly in said direction;
a link pivotally connecting each gripper arm to the hydraulic actuator, whereby linear movement of the hydraulic actuator causes movement of the gripper arms between the first and second positions.
